(19) United States
(12) Patent Application Publication
(10) Pub. No.: US 2010/0010932 A1
(43) Pub. Date: Jan. 14, 2010

(54) SECURE WIRELESS DEPOSIT SYSTEM AND METHOD

(76) Inventors: Simon Law, Mississauga (CA); Dennis Taksing Poon, Mississauga (CA); Razim Farid Samy, Mississauga (CA); Jim Chi-Yin Law, Mississauga (CA); Dai Van Duc Nguyen, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/500,395

(22) Filed: Jul. 9, 2009

Related U.S. Application Data
(60) Provisional application No. 61/129,649, filed on Jul. 9, 2008.

(51) Int. Cl. G06Q 40/00

(52) U.S. Cl. 705/42

(57) ABSTRACT

A system and method is provided for registering a user or a wireless device and executing a transaction of funds from a third party account to a prepaid account. The wireless device is in secure communication with an administrating server over a network. The administrating server is in communication with a third party entity, via a third party entity server, as well as with a prepaid server. In the initial registration process, the user provides the credentials for accessing the third party account using the wireless device. The credentials are stored on the wireless device, administrating server, or both. In subsequent transactions, the user enters in the amount to be deposited into the prepaid account and the credentials are automatically retrieved from storage for authentication. If authenticated, the transaction is executed by the administrating server.

This application claims priority from U.S. provisional application No. 61/129,649 filed on Jul. 9, 2008, the contents of which are incorporated herein by reference.

### TECHNICAL FIELD

The following relates generally to secure wireless transactions and more specifically to a wireless application in which a user can utilize a wireless device to initiate a deposit transaction to an administrating server, directing the deposit of funds into the users second account from a first account.

### DESCRIPTION OF THE RELATED ART

The popularity of prepaid systems has increased steadily over the last decade. Prepaid systems allow companies and organizations to maintain user accounts containing money or other forms of credit that can be redeemed in exchange for goods and services. Such systems are desirable because they free users from having to carry and use cash, checks, or credit cards in order to pay for services, and also because they allow the company or organization to offer additional value-added features to their payment systems such as incentives programs. Common applications of prepaid systems include university or college ‘campus card’ debit systems, cell phone carrier prepaid plans, retailer gift certificates, and financial institution cash cards.

Prepaid accounts are typically accessed through a magnetic strip card swiped at a terminal reader, but may also be accessed through other means such as smart cards, Radio Frequency Identification (RFID) tokens, or online through the Internet.

However, all prepaid systems typically require the user to add additional funds to their accounts on a regular basis. There exist several means to do this, such as automatic deposit machines, manned terminal systems, and online systems. However, these means can have drawbacks. Automatic deposit machines require a significant up-front capital cost along with continuing maintenance costs, especially considering the number of such machines needed to achieve acceptable coverage over a large area such as a college campus or an amusement park. Manned terminals require personnel for operation, incurring staffing costs and restricting their operation to limited time frames. Web based solutions can lower staffing and equipment costs, but they do not provide point-of-sale or ad-hoc convenience.

The issues of operating cost and customer convenience for prepaid deposit systems can be resolved through the use of wireless technology. Wireless devices are becoming ubiquitous. Many people today own a cell phone. PDA, or other wireless device. In addition, most of these people carry their devices wherever they go. Therefore a prepaid deposit system that can operate on commonly available wireless devices and networks extends the user the convenience to add funds at any time and location, while reducing equipment costs for the company since the system operates on customer devices.

Unfortunately, with the convenience and flexibility of such a service come opportunities for theft, fraud and/or abuse resulting in financial, identity, information and/or productivity loss. The account holder only becomes aware of the unauthorized access and/or usage of the information and/or account after the fact when a monthly account summary or notice is given. As a result, financial and identity information and/or productivity are lost both directly and indirectly as the information and/or account holder tries to correct the theft, fraud and/or abuse.

Although current practices exist to prevent and deter fraud, such practices do not keep up with the pace of technology change. In addition, new channels are being created from this technology change that allows individuals to initiate wireless deposit requests using secure/high encryption that was not possible before. Therefore, there is an urgent need for a secure transaction environment to thwart the fraudulent activities in such services.

### SUMMARY

A secure wireless deposit system is provided, whereby a user can utilize a wireless device to initiate a deposit transaction to an administrating server, directing the transfer of funds into the user's second account from a first account. A secure encryption algorithm is used to secure the wireless channel during the transaction to provide protection against theft and fraud.

The wireless deposit system is primarily comprised of an administration server, a second account server, a first account entity or first account server, and a user's wireless device. Communications between the wireless device and the administrating server are secured using encryption schemes. Further, a database is linked to the administrating server to retain user information.

The connections between the user's wireless device and administration server are secured using encryption schemes. Two methods of security schemes for use herein are symmetric-key encryption and public-key encryption.

Therefore, in one aspect a secure wireless deposit system is provided. A secure transaction is also provided and is implemented by encryption schemes to reduce the possibility of identity theft and fraud and thereby reducing the potential financial cost that could occur as a result thereof. This provides the user with a greater sense of convenience by making prepaid deposits more readily accessible. The system is simple and easy to implement, as well as low in cost by employing a low number of hardware that is widely available to consumers.

A method for transferring an amount of funds from a first account to a second account is also provided, comprising an initial registration and one or more transactions. In the initial registration a wireless device receives one or more credentials for accessing the first account and then, the one or more credentials are stored on any one of an administrating server, the wireless device, or combination thereof, wherein the administrating server is in communication with the wireless device. During the initial registration, the administrating server confirms that the one or more credentials are authentic, thereby allowing access to the first account. In each of the one or more transactions, the wireless device receives a desired amount of funds to be transferred to the second account and then, the wireless device transmits the desired amount to the administrating server so that the administrating server can transfer the amount from the first account to the second account.

In another embodiment, a method for transferring an amount of funds from a first account to a second account comprises an initial registration wherein an administrating server receives from a wireless device one or more credentials for accessing the first account, such that the administrating server is in communication with the wireless device. Furthermore, during the initial registration, the one or more credentials are stored on any one of the administrating server, the wireless device, or combination thereof and the administrating server confirms that the one or more credentials are authentic for accessing the first account. The method also comprises one or more transactions wherein for each of the one or more transactions, the administrating server receives from the wireless device a desired amount of funds to be transferred to the second account, and the administrating server transfers the amount from the first account to the second account.

### BRIEF DESCRIPTION OF THE DRAWINGS

Embodiments will now be described by way of example only with reference to the appended drawings wherein:

FIG. 1 is a schematic diagram to illustrate a secure wireless deposit system.

FIG. 2 is a flow diagram that illustrates steps for executing a deposit request.

FIG. 3 is a flow diagram of an initial registration process in which credentials are stored on a wireless device.

FIG. 4 is a flow diagram of part of an initial registration process in which the steps of storing and encrypting the credentials proceed the step of the user entering the credentials into the wireless device.

FIG. 5 is a flow diagram of a transaction process in which credentials are stored on a wireless device.

FIG. 6 is a flow diagram of an initial registration process in which a portion of the credentials are stored on a wireless device and another portion of the credentials are stored on an administrating server.

FIG. 7 is a flow diagram of a transaction process in which a portion of the credentials are stored on a wireless device and another portion of the credentials are stored on an administrating server.

FIG. 8 is a flow diagram of an initial registration process in which credentials are stored on an administrating server.

FIG. 9 is a flow diagram of a transaction process in which credentials are stored on an administrating server.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

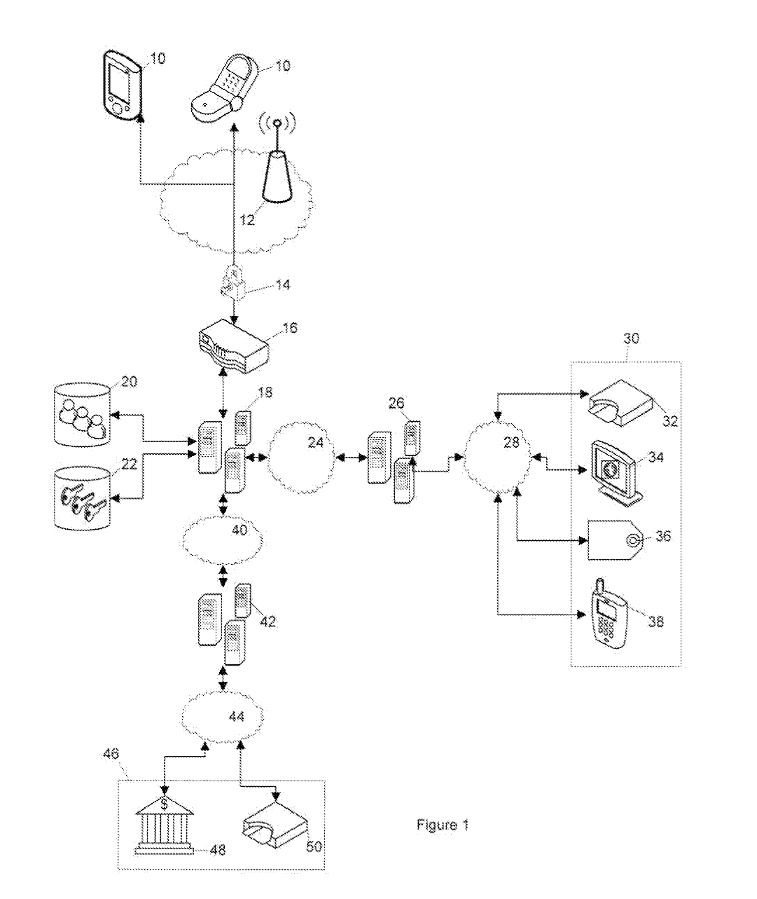

FIG. 1 shows a user's wireless device 10, administrating server 18, second account server 26, and first account server 42. It can be appreciated that an example of a second account server 26 is a prepaid account server, and an example of a first account server 42 is a third party entity server. The servers are computing devices having memory for storing data and computer executable instructions. As discussed below, the wireless device 10 and the servers are in communication with one another.

The purpose of the second account server 26 is to manage the user accounts for a second account system and process transactions for the second account system. In other words, the second account server 26 interfaces with the second account. User accounts for the second account system or prepaid system are typically accessed through various devices 30 that include, but are not limited to, a magnetic swipe card 32, an internet web browser 34, a smart card 36, or an RFID-enabled device 38. Each of the aforementioned devices, in addition to the administrating server 18, communicates with the second account server 26 over a system-dependent second account network or prepaid network 28 in order to access the user second accounts.

The first account server 42 (e.g. third party entity server) provides an interface to a first account entity 46 (e.g. third party entity) from which funds can be obtained to deposit or transfer into the users second account. The first account entity 46 could be a financial institution where the user holds a credit card account or bank account 48, or a separate prepaid system 50. It can be appreciated that first account entities 46 include any financial accounts from which monetary funds can be withdrawn. Examples of first account entities include bank accounts, credit card accounts and PayPal™. It is understood that the separate second account system (e.g. prepaid system) can be accessed via similar means as the aforementioned first account system. The “third party” or first account entity 46 can also be understood as a separate application residing on the same server as the second account and/or administrating servers, or a separate server residing within the same company or financial institution. For example, this can be dependant on whether the first account server 42 (e.g. third party entity server) resides with the same financial institution or organization as the second account server 26 (e.g. prepaid server). In other words, the functions of the first account server 42 and administrating server 18 may reside on the same server; the functions of the second account server 26 and administrating server 18 may reside on the same server; the functions of the first account server 42 and second account server 26 may reside on the same server; or, in yet another embodiment, the functions of all the servers (e.g. 18, 26, 42) may all reside on a common server. It can be appreciated that the first account server 42 communicates with the first account entity 46 (e.g. third party entity) over a system-dependent network 44.

The administrating server 18 is the central processing entity of the system. This administrating server 18 can include one or more servers or mainframes connected together to handle high volumes of traffic and processing, and is responsible for authenticating the user for the purpose of operations on said user's prepaid account. In addition, upon successful authentication, the administrating server 18 is responsible for initiating a request to the first account server 42 to obtain the desired amount of funds to be deposited in the user's second account, then depositing those funds into the user's second account via the second account server 26.

The administrating server 18 includes a database that stores the account information of the system's users 20. This information is used to associate a request from a wireless device 10 with a users second account. It can also be used to authenticate user provided credentials in order to authorize deposit requests. It is noted that the administrating server 18 can also forward requests for authentication to the prepaid server 26 or third party entity server 42 if needed. The administrating server will also include the secure storage 22 of encryption keys and/or certificates used to create secure connections with the wireless devices.

The wireless gateway 16 is an entity that bridges the administrating server with the wireless network 12. It translates communication requests and information into wireless network protocols so that the wireless device can communicate with the administrating server. Typical wireless gateways are short message service centers (SMSC), multimedia message service centers (MMSC), gateway GPRS (General Packet Radio Service) service nodes (GGSN), and CDMA2000 (Code Division Multiple Access) Packet Data Serving Nodes (PDSN). For instance, a wireless device 10 will package 140 bytes into a message that can be received by the SMSC and forwarded to the administrating server. The administrating server 18 can also use SMS to send a message back to the wireless device through the SMSC. Alternatively, the system can use a packet based technology using the GGSN or CDMA2000 PDSN. Typically, GPRS or CDMA2000 would be used for connection-oriented connections while short message service/enhanced message service/multimedia message service (SMS/EMS/MMS) would be used for connectionless communication. The system contemplates a method to operate on either connection-oriented or connectionless protocols or both.

The wireless device 10 is an entity that allows the user to initiate deposit requests. The wireless device should be computationally capable of creating an encrypted secure connection within a reasonable time. In the preferred embodiment, the wireless device 10 is also able to store an application. This wireless application will be responsible for securely storing certificates or encryption keys, or both, and user information. This stored information allows the user to initiate a deposit request, set up the secure connection to the administrating server 18, transmit the deposit request, receive the deposit request response from the administrating server 18, and display the response to the user. Typically the wireless device 10 is a mobile cellular phone, a wirelessly enabled personal digital assistant (PDA), and/or a mobile cellular capable personal digital assistant such as a smart-phone. Other examples of wireless devices include desktops, laptops, netbooks and other mobile devices.

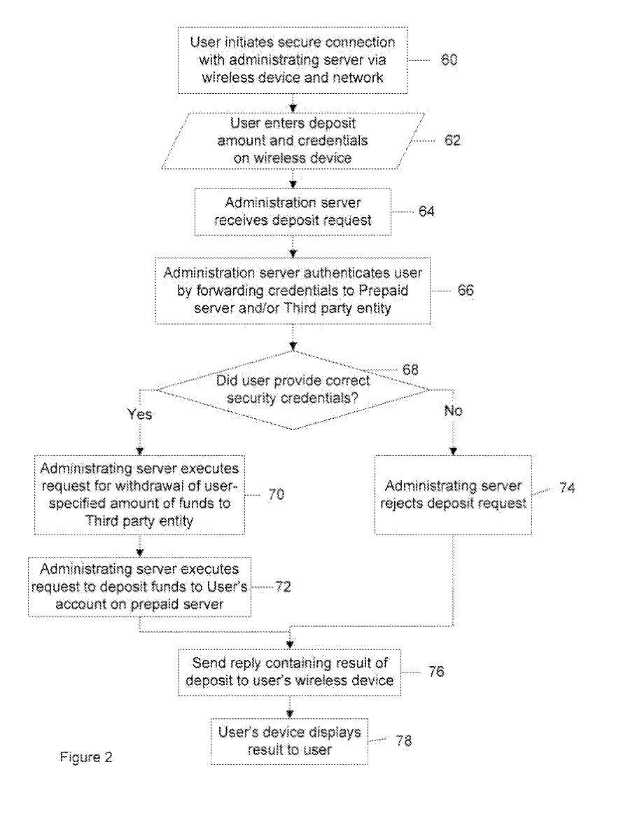

FIG. 2 is a flow chart illustrating the steps needed for a user to complete a deposit using a wireless device 10. For instance, user X requests a deposit of amount Y into the second account Z from the first account W. User X will use the wireless device 10 with the proper installed software to establish a secure connection with the administrating server 18 via a wireless network (60). User X will then enter the deposit amount Y, and the needed credentials to authorize the deposit (62). The deposit request containing Y and the credentials is then sent to the administrating server 18 to be processed (64).

The credentials needed to authorize the transaction depend on the methods of authorization required by the system. In some embodiments, there are three possible methods of authorization: a) by a PIN or personal password on the wireless device 10 by the administrating server 18, b) by a PIN or personal password on the wireless device 10 via the administrating server 18 by the prepaid server 26, and c) by a PIN or personal password on the wireless device 10 via the administrating server 18 by the third party entity 46. These methods can be used singly or in combination with each other, as required by the system. For example, access to the second account Z (e.g. prepaid account) could be protected by a password scheme and the first account W (e.g. third party account) could be a credit card account. User X would thus be required to present the password for Z as well as credit card information such as credit card number, expiry date, or validation code for W in order to successfully have his/her request authorized.

It is advantageous to reduce the amount of credentials that the user is required to enter in order to improve the user experience. This can be accomplished by harmonizing user authentication where possible among the administrating server 18, second account server 26, and first account entity 46 through means such as a common password or PIN between all three entities. Another possible method to reduce the amount of credentials to be entered is to store some of the credentials on the wireless device 10. The stored credentials can then be automatically sent as part of any subsequent request. To allay security concerns, the stored credentials can be put into the wireless device's secure storage and/or stored in an encrypted form. Yet another possible method is to securely store some of the user credentials on the administrating server 18.

To complete the authorization, the administrating server 18 will perform its own check against the user-supplied credentials, and/or forward said credentials to the second account server 26 and/or first account entity (66).

If the request is successfully authorized (68) then the administrating server 18 will execute the request in two steps. First, the administrating server 18 will execute a request to the first account entity 46 for the withdrawal of amount Y of funds from user X's first account W with the first account entity 46 (70). After this is complete, the withdrawn funds are deposited into user X's second account Z (72).

If the request is not successfully authorized, the administrating server 18 will reject the request and no transfer of funds is made (74).

Upon completion of the request, the administrating server 18 can return a reply to user X's wireless device 10 via the wireless network 12 (74). This reply can contain an indication of the success or failure of the execution of the request and other information such as post-deposit balance of the second account Z. The wireless device 10 will receive the reply and automatically display its contents to the user (78).

The connections that are established between the administrating server 18 and the user's wireless device 10 are secured using encryption schemes 14. Using these security schemes 14 to secure the connection provides the benefits of privacy, authentication, message integrity and non-repudiation. Security schemes that can be used are symmetric-key encryption and public-key encryption.

Symmetric-key encryption is used to secure the connection for the purposes of making deposit requests. For the symmetric-key encryption scheme, the wireless device 10 and the administrating server 18 need to negotiate and agree upon a symmetric key and a unique device identifier before a request can take place. The device identifier is used to associate the symmetric key with the device, so that the administrating server will be able to differentiate and decrypt communications initiated by different devices. The negotiated key can be generated using a combination of random values generated by both the wireless device and the administration server and/or other known quantities.

A public-key encryption scheme is used to secure the channel or connection between the wireless device 10 and administrating server 18 so that the symmetric key can be negotiated. The wireless device 10 uses the public key to encrypt a negotiation initialization message. This message contains the wireless device-specific component of the negotiation as well as the user credentials. The administrating server 18 decrypts this message and extracts the user credentials. The credentials are then validated by the administrating server, second account server and/or first account entity. Once the identity of the user has been confirmed, the administrating server returns the server-specific component of the negotiation data as well as a unique device identifier to the wireless device 10 over the aforementioned public-key encrypted channel. Now both the wireless device 10 and administrating server 18 hold the data needed to create the symmetric key, and the wireless device 10 has obtained a unique device identifier.

All request messages will contain the aforementioned unique device identifier as well as a unique sequence number to identify the specific transaction. This will assist in nullifying replay attacks. As in the original symmetric-key negotiation process, the user will also supply credentials to authenticate himself or herself to the authorization server on each request. The credentials will be sent over the secure channel to be verified by the administration server 18. As disclosed previously, this channel is encrypted by the pre-established symmetric key. The symmetric-key encryption scheme is ideal for communicating over a channel such as SMS/EMS/MMS. Improper encryption or incorrect credentials would cause the request to be aborted.

On the wireless device 10, proprietary software is used to send/receive messages to/from the administrating server 18. This software must handle various security schemes and communication channels.

In the case where some of the user's credentials are stored within the wireless device 10, the credentials will be stored within the device's secure storage. In the absence of such secure storage, the credentials can be encrypted using public-key encryption and stored in that encrypted form. This will ensure that even if a users wireless device 10 is stolen, or even if the device's symmetric key is compromised, the user's credentials remain safe from theft.

Similarly, encryption keys and/or user account information stored on the administrating server 18 can be protected by storing said data in secure storage.

In order to protect the integrity of the application, it can be delivered to the customer through a secure channel protected by a public-key encryption scheme such as Secure Sockets Layer (SSL) or Transport Layer Security (TLS). The precise SSL and TLS protocols will not be described in detail herein, since they are well known protocols for those skilled in the art. Once the application is obtained, the customer is simply expected to follow the instructions and install it.

In another embodiment, a method of transferring funds from a first account to a second account includes an initial registration process, whereby information related to credentials to access the first account are provided by the user and authenticated. During the initial registration process, the credentials needed to access the first account are stored in any one of the wireless device 10, administration server 18, first account server 42, second account server 26, or combination thereof for retrieval in subsequent transactions. After the initial registration process, the user needs, at a minimum, to enter in the amount of funds to be transferred from the first account to the second account. In particular, the user does not need to provide credentials or information to identify or access the first account during subsequent transactions since such credentials were previously provided in the initial registration process and are automatically retrieved from the device 10, administrating server 18, or both when the user submits a transaction request.

Storing the credentials during the initial registration process advantageously reduces or eliminates the need for the user to provide information that identifies the first account for each transaction between the first account and second account. More specifically, for example, where the credentials for accessing the first account include a credit card number, the user only needs to provide the system with the credit card information once during the initial registration process. This allows the user to complete transactions more quickly since less information or credentials are required to be input or provided by the user during each transaction. Moreover, less data is being transmitted with each transaction. Further, by reducing or eliminating the need for entering the credential information during each transaction, the security risk is decreased. For example, reentering a credit card number during each transaction increases the risk for an attacker to steal or copy the credit card information. It can thus be understood that providing an initial registration process whereby credential information is provided, and separate transaction process provides a number of advantages for a wireless deposit system and method.

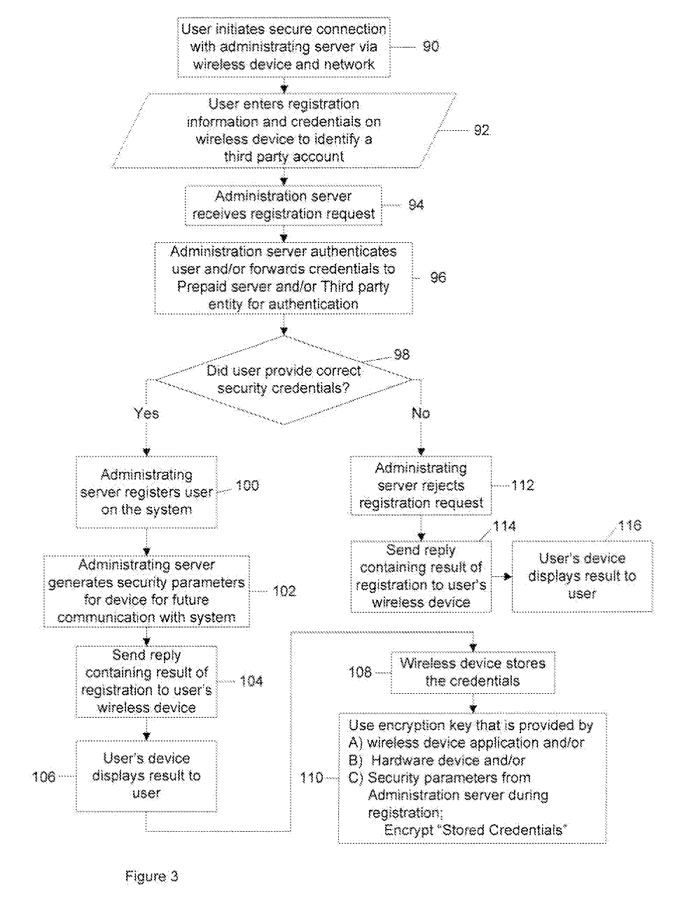

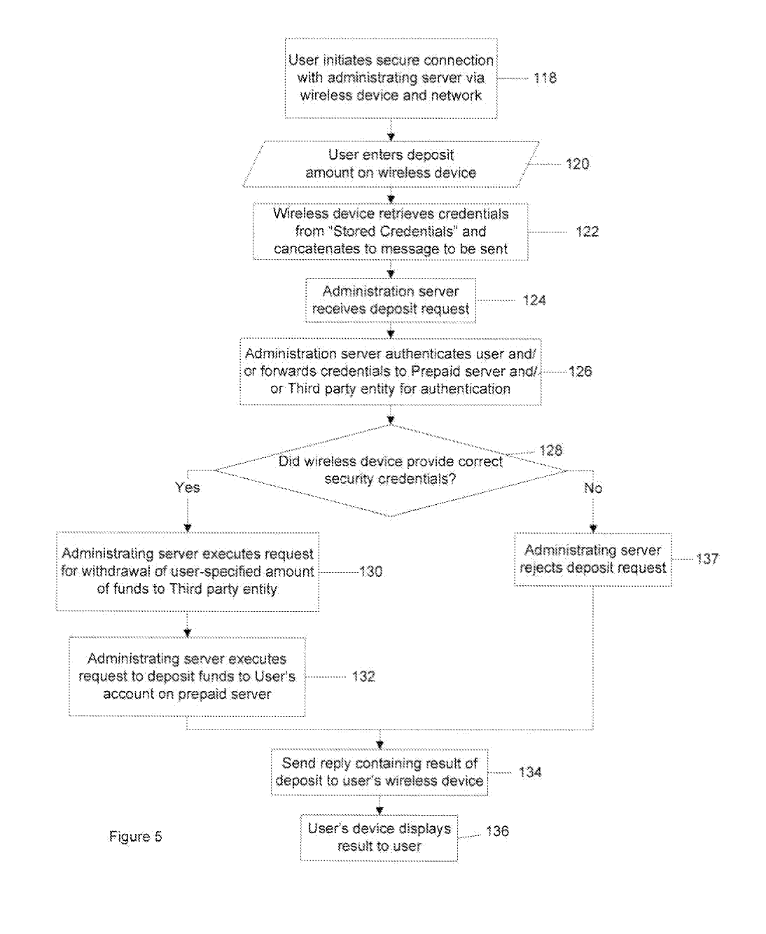

FIGS. 3 and 5 illustrate the initial registration process and subsequent transaction process, respectively, whereby the credentials for accessing the first accounts are stored on the wireless device 10.

Turning to FIG. 3 an initial registration process is provided. At step 90, the user initiates a secure connection with the administrating server 18 via a wireless device 10 and the network 12. Upon initiating a secure connection, at step 92, the user provides registration information and credentials on the wireless device 10 to identify a first account. It can be appreciated that credentials to identify a first account include, for example and without limitation, a credit card number, a bank number, an identification name, a password, or a pin number, or combinations thereof. Any information and credentials that identifies a first account as well as allows a user to access the first account applies to the principles described herein. The registration information and credentials are sent from the wireless device 10, via the network 12, to the administration server 18 as registration request at step 94. It is noted that the information and credentials may be encrypted by the wireless device 10 prior to transmission, and may be decrypted by the administrating server 18 upon receipt. At step 96, the administrating server 18 authenticates the user based on the information and encryption scheme, and then forwards the credentials to either the second account server 26, or first account entity 46, or both in order for the user to access the first account. In one embodiment, the first account entity 46 may verify the credentials, thereby allowing the user to access the first account. In another embodiment, the second account server 26 may have an existing relationship with the first account entity 46, whereby a user's first account and second account are linked. If there is an existing relationship between the second account server 26 and the first account entity 46, the credentials may be forwarded to the second account server 26 so that the second account server 26 may authenticate the credentials, thereby allowing the user to access to the first account. Similarly, both the second account server 26 and first account entity 46 may authenticate the credentials in order for the user to access the first account. Thus, at step 98, either the second account server 26, or the first account entity 46, or both, verify the credentials provided by the user.

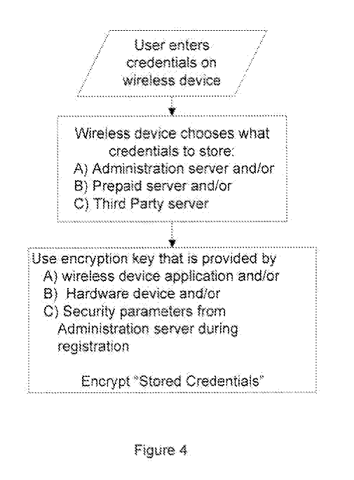

Continuing with FIG. 3, the second account server 26, or the first account entity 46, or both, send a message to the administrating server 18 regarding whether the correct security credentials were provided. If so, at step 100, the administrating server 18 confirms or acknowledges the credentials are authentic and then registers the user or the wireless device 10 on the system. The administrating server 18 then generates security parameters for the wireless device 10 for future communication with the transaction system, as per step 102. Thus, since the wireless device 10 is registered, the user can access the system through the wireless device 10. Then, at step 104, the administrating server 104 sends a reply containing the result of the successful registration to the user's wireless device 10. The reply may also contain security parameters that are to be stored on the wireless device 10. At step 106, upon the wireless device 10 receiving the reply from the administrating server 18, the wireless device 10 may display the results to the user. At step 108, the wireless device 10 stores the credentials within its memory for subsequent transactions. At step 110, the wireless device 10 encrypts the stored credentials using an encryption key that is provided by any one of the following: the wireless device's application, an external hardware device, the security parameters transmitted by the administrating server 18, or combinations thereof. It can be appreciated that the order of steps 108 and 110 may be interchangeable. It can further be appreciated that in other embodiments, steps 108 and 110 can be executed at any stage proceeding step 92, for example, after the user enters the registration information and credentials to identify a third party account on to the wireless device 10. Such an example is shown in FIG. 4. It can also be understood that in another embodiment, step 110 is not required in order to complete the registration.

Continuing with FIG. 3, at step 98, if it is determined that the user did not provide the correct security credentials, then the administrating server 18, at step 112, rejects the registration request. At step 114, the administrating server 18 then sends a reply containing a result of the unsuccessful registration to the user's wireless device 10, such the wireless device 10, at step 116, displays the result to the user.

In FIG. 5, after successfully registering the user, a subsequent transaction process is provided whereby the credentials for accessing the first accounts, which are stored entirely on the wireless device 10, are retrieved to execute a transaction. At step 118, the user initiates a secure connection with the administrating server 18 via the wireless device 10 and network 12. The user enters into the wireless device 10 the desired amount to be transferred from the first account to the second account, as per step 120. It is noted that the user does not need to provide information or credentials, or both, for identifying the first account during the transaction process, since this information was previously provided and stored during the initial registration process. At step 122, the wireless device 10 automatically retrieves the credentials that have been stored on its memory and sends both the desired deposit amount and credentials to the administrating server 18; this is a deposit request. It is noted that the credentials may be in an encrypted form. If so, the encrypted credentials are decrypted by the authorized entity that wishes to verify or authenticate the credentials. At step 124, the administrating server 18 receives the deposit request from the wireless device 10. Thereafter, at step 126, the administrating server 18 authenticates the user. Alternatively, or in combination, the administrating server 18 forwards the credentials to the second account server 26 or first account entity 36, or both, for authentication. Therefore, any one of the administrating server 18, second account server 26, first account entity 46, or combinations thereof, may authenticate the user 10. At step 128, it is determined if the wireless device 10 provided the correct or authentic credentials, which is confirmed or acknowledged by the administrative server 18. It can be understood that this can be a way to determine if the user has already been registered with the system. If the administrating server 18 confirms that the credentials are authenticated or that the user has been registered, then at step 130, the administrating server 18 executes the request for withdrawal of the user-specified amount of funds from the first account server 42. The administrating server 18, at step 132, then executes the request to deposit or transfer the amount of funds to the second account on the second account server 26. At step 134, the administrating server 18 sends a reply to the wireless device 10 containing the result of the deposit, and the wireless device 10, at step 136, displays the results to the user. If, however, the wireless device 10 did not provide the correct or authentic credentials, at step 137, or if the administrating server 18 confirms that the user has not been registered, then the administrating server 18 rejects the deposit request and alerts the wireless device 10, as per steps 134 and 136.

It is also noted that in step 120 of FIG. 5, the user may also provide secondary credentials for identifying and accessing the second account, in addition to the deposit amount. Although not shown, the secondary credentials may also be authenticated by any one of the administrating server 18, second account server 26, first account server 46, or combinations thereof, and, if authenticated, the user would be allowed to access the second account. In another embodiment, these secondary credentials may be stored beforehand, for example on the wireless device 10, or administrating server 18, or both, during the initial registration process.

It can be appreciated that storing the credentials on a wireless device 10 during the initial registration process, and retrieving the same during the transaction process advantageously reduces the liability with respect to the administrating server's security. For example, should the administrating server 18 be compromised, the critical credential information would not be available to the attacker since each user's credential information would be stored on the respective user's wireless device 10.

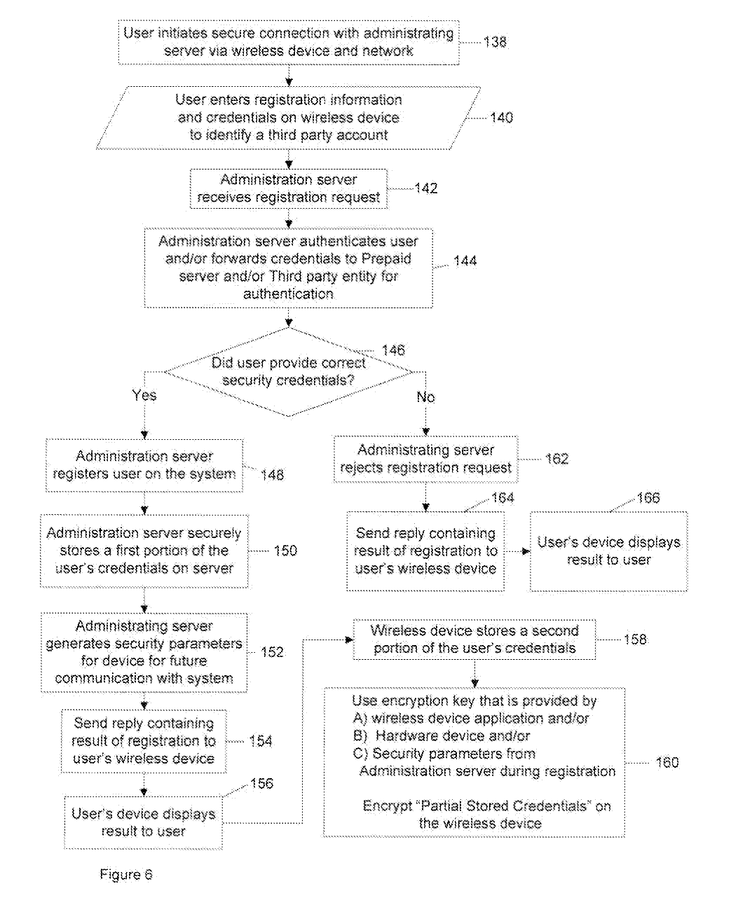

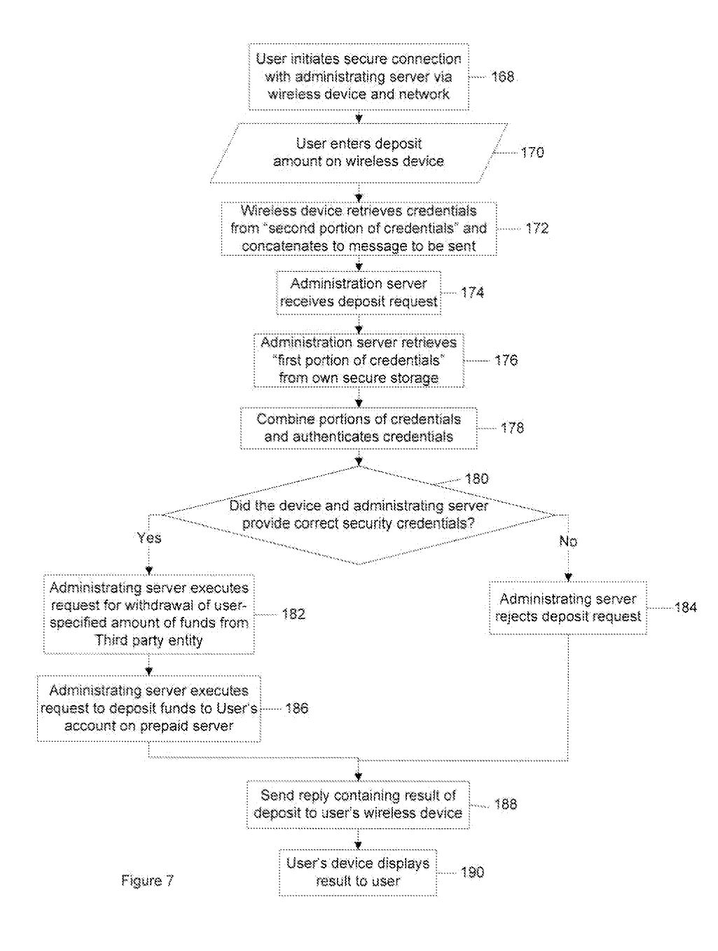

FIGS. 6 and 7 illustrate the initial registration process and subsequent transaction process, respectively, whereby the credentials for accessing the first accounts are stored partially on the wireless device 10 and partially on the administrating server 18.

Turning to FIG. 6, an embodiment of an initial registration process is provided. At step 138, the user initiates a secure connection with the administrating server 18 via the wireless device 19 and the network 12. At step 140, the user then provides on the wireless device 10 the registration information and credentials to identify a first account. This information and credentials are sent to the administrating server 18, whereby the administrating server 18 receives the registration request in step 142. Similar to step 96, any one of the administrating server 18, second account server 26, first account entity 46, or combinations thereof may authenticate the credentials, as per steps 144 and 146. If the user provides the correct or authentic credentials, as step 148, the administration server 18 registers the user (e.g. the user's wireless device 10) on the system. In other words, the administrating server 18 has confirmed or acknowledges that the credentials provided by the user are authentic. At step 150, the administration server 18 securely stores a first portion of the user's credentials in its memory. The administrating server 18 then generates security parameters for the wireless device 10 for future communication with the system. These security parameters are used to create a secure channel with the administrating server 18 for subsequent communications between the server 18 and wireless device 10. During the initial signup process, the wireless device 10 and administrating server 18 use a less efficient public/private key encryption scheme. For subsequent bulk encryption, the wireless device 10 and server 18 negotiate a unique key for future communication. This establishes a secure or cryptographic channel for future use. The administrating server 18 then sends a reply containing the result of the registration to the user's wireless device 10, as per step 154. The wireless device 10 displays the results to the user, as per step 156. At step 158, the wireless device 10 stores a second portion of the user's credentials on the wireless device's memory. The wireless device 10 may then use an encryption key to encrypt the second portion of the credentials at step 160. The encryption key may be provided by the wireless device's application, an external hardware device, the security parameters generated by the administrating server 18, or combinations thereof.

It can be appreciated that the first and second portions of the credentials may, for example, be portions of a name, credit card or bank account number, password, or combinations thereof. For example, a first portion contains the bank account number, while the second portion includes the password used to enter the bank account. In yet another non-limiting example, the first portion contains a subset of a credit card number, while the second portion contains an ancillary subset of the same credit card number. It can be appreciated that any method or configuration for establishing a first portion and a second portion of the credentials are applicable to the principles described herein.

Continuing with FIG. 6, if it is determined that the user did not provide the correct security credentials, as per step 146, then the administrating server 18 rejects the registration request at step 162. Then, at steps 164 and 166, the result is sent to the wireless device 10 and displayed on the device 10 for the user.

In FIG. 7, a transaction process if provided. At step 168, the user initiates the secure connection between the administrating server 18 and wireless device 10. At step 170, the user enters the desired deposit amount (e.g. desired amount of funds to be transferred from the first account to the second account) on the wireless device 10. It is noted that the user does not need to enter in information or credentials for identifying the first account, since it has been already provided and stored during the initial registration process. At step 172, the wireless device 10 retrieves the stored second portion of the credentials from its memory and sends this, as well as the deposit amount, to the administrating server 18. Upon receipt of the deposit request (step 174), the administrating server 18 retrieves the first portion of the credentials from its own memory, as per step 176. The administrating server 18 may then combine the first and second portions of the credentials together and forward the credentials to the second account server 26, first account entity 46, or both in order to authenticate the user, as per step 178. It can be appreciated that in another embodiment, the first and second portions of the credentials may be authenticated separately and need not be combined. If the credentials provided by the wireless device 10 and administrating server 18 are verified (step 180), then the administrating server 18 executes the request for withdrawal of the user-specified amount of funds from the third party entity 46 (step 182). In other words, the administrating server 18 has confirmed whether the credentials retrieved from the device 10 and server 18 are authentic. At step 186, the administrating server 18 executes the request to deposit the funds to the user's second account on the second account server 26. At step 188, the administrating server 18 sends a reply containing the result of the deposit to the user's wireless device 10, and then at step 190, the user's device 10 displays the result. If the credentials provided by the wireless device 10 and administrating server 18 are not verified (step 180), then the administrating server 18 rejects the deposit request (step 184). The user is then notified as per steps 188 and 190.

It can be appreciated that storing a portion of the credentials on the wireless device 10 and another portion on the administrating server 18, provides increased security. For example, should any one of the wireless device 10, administrating server 18, or both, be compromised, an attacker would not be able to retrieve the credential information (e.g. credit card number or bank card number) unless the attacker is able to match and combine the separate portions of the credentials.

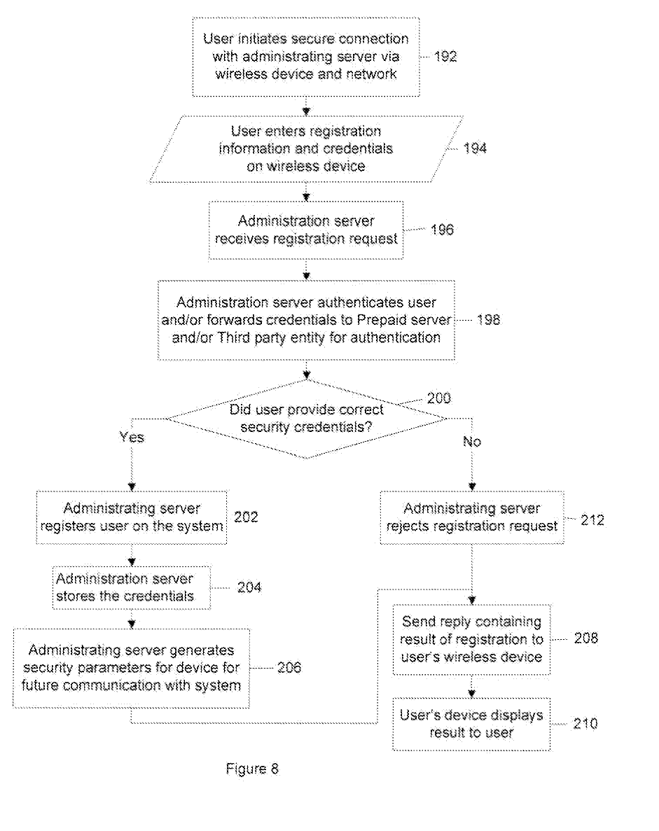

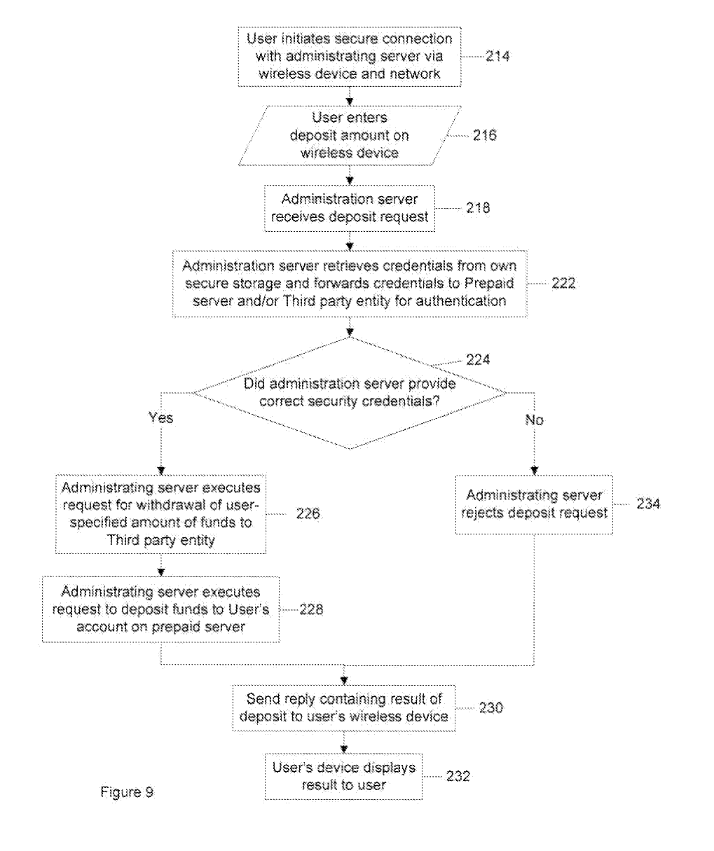

FIGS. 8 and 9 illustrate the initial registration process and subsequent transaction process, respectively, whereby the credentials for accessing the first accounts are stored on the administrating server 18.

Turning to FIG. 8, the user initiates a secure connection between the wireless device 10 and the administrating server 18 (step 192). The user then provides on the wireless device 10 registration information and credentials for accessing the first account (step 194). This information (e.g. registration request) is received by the administrating server 18 (step 196). The administrating server 18 then authenticates the credentials. In combination or in the alternative, the administrating server 18 may forward the credentials to the second account server 26, first account entity 46, or both, for authentication. If the credentials are verified (step 200), the administrating server 18 then registers the user on the system (step 202). The administrating server 18 then stores the credentials in its memory (step 204). The administrating server 18 generates security parameters for the wireless device 10 for future communication with the system (step 206). The results of the registration are conveyed to the wireless device 10 and user through steps 208 and 210, respectively. If the credentials are not verified (step 200), the administrating server 18 rejects the registration request (step 212).

Turning to FIG. 9, after the initial registration process is complete, the user may, if not already done so, initiate a secure connection with the administrating server 18 (step 214). At step 216, the user enters the deposit amount (e.g. amount to be transferred from the first account to the second account) on the wireless device 10. It is noted that the user does not need to enter in information or credentials for identifying the third party account, since it has been already provided and stored during the initial registration process. The administrating server 18 receives the deposit request from the wireless device 10 (step 218). Thereafter, the administrating server 18 retrieves the stored credentials from its memory and authenticates the credentials, either directly or through the first account entity 46 or second account server 26, or both (step 222). If the administrating server 18 provided the correct credentials (step 224), the withdrawal from the first account (step 226) and deposit to the second account (228) are executed by the administrating server 18. The results of the deposit are conveyed to the wireless device 10 and user in steps 230 and 232, respectively. If however, the security credentials are not correct, the administrating server 19 rejects the deposit request and notifies the user (step 234).

It can be appreciated that storing the credentials on the administrating server 18 advantageously reduces the liability or risk of compromising the credentials, for example, should the wireless device 10 be compromised. Moreover, storing the credentials on the administrating server 18 reduces the number of times the credential information is transferred from the wireless device 10 to the administrating server. This advantageously reduces the risk of an attacker intercepting transmissions containing credentials. Further, less data is sent between the wireless device 10 and administrating server 18 during each transaction. This in turn, among other things, increases the data transmission efficiency.

In another embodiment, a transaction process is provided where the credentials are authenticated based on the authentication during the initial registration process. Although not shown, instead of undergoing another complete authentication process during the transaction process, the administrating server 18, or any of the other servers, keeps a record that the credentials and the user have been authenticated during the initial registration process. Therefore, upon the administrating server 18 receiving a request for a deposit transaction from the wireless device 10, the administrating server 18 determines if the retrieved credentials have been previously authenticated according the record. If so, the transaction is executed by the administrating server 18. If not, the administrating server 10 may proceed to authenticate the credentials, or in another embodiment, may reject the request for a deposit transaction. This advantageously allows the administrative server 18 to withdraw an amount of funds from the first account without having to retrieve the stored credentials and confirm that the stored credentials are authentic.

In yet another embodiment, not shown, a transaction process is provided where the user provides secondary credentials in addition to the deposit amount, whereby the secondary credentials are used to identify and access the second account (e.g. prepaid account). The secondary credentials may be authenticated by any one of the administrating server 17, second account server 26, first account server 46, or combinations thereof, and, if authenticated, the user would be allowed to access the second account. In another embodiment, these secondary credentials may be stored beforehand, for example on the wireless device 10, or administrating server 18, or both, during the initial registration process.

While the basic principles of this invention has been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention, and not construed in a limiting sense.

1. A method for transferring an amount of funds from a first account to a second account comprising:
an initial registration wherein:
a wireless device receives one or more credentials for accessing said first account;
said one or more credentials are stored on any one of an administrating server, said wireless device, or combination thereof, said administrating server in communication with said wireless device; and
said administrating server confirming said one or more credentials are authentic to allow access to said first account; and
one or more transactions wherein:
for each of said one or more transactions said wireless device receives a desired amount of funds to be transferred to said second account; and
said wireless device transmits said desired amount to said administrating server so that said administrating server can transfer said amount from said first account to said second account.

2. The method in claim 1 wherein during said one or more transactions, said one or more credentials are retrieved from said wireless device, said administrating server, or both, so that said administrating server can confirm said one or more credentials are authentic.

3. The method in claim 2 wherein said credentials are stored on said wireless device during said initial registration and are retrieved from said wireless device during said one or more transactions.

4. The method in claim 2 wherein a first portion of said one or more credentials are stored on said wireless device and a second portion of said one or more credentials are stored on said administrating server during said initial registration, and said portions are retrieved from said wireless device and said administrating server during said one or more transactions.

5. The method in claim 2 wherein said credentials are stored on said administrating server during said initial registration and are retrieved from said administrating server during said one or more transactions.

6. The method in claim 1 wherein during said initial registration a record indicates that said one or more credentials have been authenticated, so that during said transaction said administrating server determines if said one more credentials have been previously authenticated according to said record.

7. The method in claim 1 wherein during said initial registration, said one or more transactions, or both, said wireless device receives one or more secondary credentials for accessing said second account.

8. The method in claim 1 wherein upon said administrating server confirming said one or more credentials are authentic during said initial registration, said administrating server generates one or more security parameters used to create a cryptographic channel between said wireless device and said administrating server.

9. The method in claim 1 wherein any one of said administrating server, a first account server, a second account server, or the combination thereof, authenticate said one or more credentials, such that said first account server and said second account server are in communication with said first account server.

10. A method for transferring an amount of funds from a first account to a second account comprising:
an initial registration wherein:
an administrating server receives from a wireless device one or more credentials for accessing said first account, said administrating server in communication with said wireless device;
said one or more credentials are stored on any one of said administrating server, said wireless device, or combination thereof; and
said administrating server confirming said one or more credentials are authentic for accessing said first account; and
one or more transactions wherein:
for each of said one or more transactions said administrating server receives from said wireless device a desired amount of funds to be transferred to said second account; and
said administrating server transferring said amount from said first account to said second account.

11. The method in claim 10 wherein during said one or more transactions, said one or more credentials are retrieved from said wireless device, said administrating server, or both, so that said administrating server can confirm said one or more credentials are authentic.

12. The method in claim 11 wherein said credentials are stored on said wireless device during said initial registration and are retrieved from said wireless device during said one or more transactions.

13. The method in claim 11 wherein a first portion of said one or more credentials are stored on said wireless device and a second portion of said one or more credentials are stored on said administrating server during said initial registration, and said portions are retrieved from said wireless device and said administrating server during said one or more transactions.

14. The method in claim 11 wherein said credentials are stored on said administrating server during said initial registration and are retrieved from said administrating server during said one or more transactions.

15. The method in claim 12 wherein during said initial registration a record indicates that said one or more credentials have been authenticated, so that during said transaction said administrating server determines if said one more credentials have been previously authenticated according to said record.

16. The method in claim 10 wherein during said initial registration, said one or more transactions, or both, said wireless device receives one or more secondary credentials for accessing said second account.

17. The method in claim 10 wherein upon said administrating server confirming said one or more credentials are authentic during said initial registration, said administrating server generates one or more security parameters used to create a cryptographic channel between said wireless device and said administrating server.

18. The method in claim 10 wherein any one of said administrating server, a first account server, a second account server, or the combination thereof, authenticate said one or more credentials, such that said first account server and said second account server are in communication with said first account server.

19. A system for transferring an amount of funds from a first account to a second account comprising:
a wireless device comprising a device memory; and
an administrating server comprising a server memory,
wherein:
said wireless device is in communication with said administrating server through a network;
said wireless device able to receive from a user one or more credentials for accessing said first account during an initial registration;
said wireless device and said administrative server able to store in said one or more credentials or a portion thereof during said initial registration;
said administrating server able to confirm said one or more credentials are authentic and; if so, said administrating server able to register said user during said initial registration;
said wireless device also able to receive from said user a desired amount of funds to transfer to said second account as well as able to transmit said desired amount to said administrating server during a transaction; and
said administrating server able to confirm if said user is registered and, if so, said administrating server able to transfer said amount from said first account to said second account during said transaction.

20. The system in claim 19 wherein a first account server and a second account server are in communication with said administrating server, said first account server interfacing with said first account, and said second account server interfacing with said second account.

21. The system in claim 20 wherein said first account server and said administrating server reside on a common server, or said second account server and said administrating server reside on said common server, or said first account server and said second account server reside on said common server, or said administrating server and said first and second account servers reside on said common server.
